(19) United States
(12) Patent Application Publication
(10) Pub. No.: US 2018/0299747 A1
(43) Pub. Date: Oct. 18, 2018

(54) ADJUSTABLE FILTER ASSEMBLY AND CAMERA MODULE

(71) Applicants: LITE-ON ELECTRONICS (GUANGZHOU) LIMITED, Guangzhou (CN); Lite-On Technology Corporation, Taipei (TW)

(72) Inventors: Ti-Lun Liu, Taipei (TW); Chia-Cheng Chang, Taipei (TW)

(73) Assignees: LITE-ON ELECTRONICS (GUANGZHOU) LIMITED, Guangzhou (CN); Lite-On Technology Corporation, Taipei (TW)

(21) Appl. No.: 15/952,240

(22) Filed: Apr. 13, 2018

Related U.S. Application Data
(60) Provisional application No. 62/485,400, filed on Apr. 14, 2017.

(30) Foreign Application Priority Data
Jan. 22, 2018 (CN) 201820101412.8

(51) Int. Cl. G03B 7/08; H04N 5/225

(52) U.S. Cl. CPC G03B 7/08; H04N 5/2254

(57) ABSTRACT

An adjustable filter assembly is provided. The adjustable filter assembly includes a filter and two electrodes. The two electrodes are respectively coupled to a surface of the filter, and electrically coupled to a controller. The controller is configured to apply a voltage to the filter and control the voltage to be changed or not. The voltage causes a state of a molecular arrangement of the filter to change such that a transmittance spectrum of the filter is changed correspondingly. Also, a camera module is provided.

### CROSS REFERENCE TO RELATED APPLICATION

This application claims the priority benefits of U.S. provisional application Ser. No. 62/485,400, filed on Apr. 14, 2017, and China application serial no. 201820101412.8, filed on Jan. 22, 2018. The entirety of each of the above-mentioned patent applications is hereby incorporated by reference herein and made a part of specification.

### BACKGROUND OF THE DISCLOSURE

### Field of the Disclosure

The disclosure is related to an optical module, and particularly to an adjustable filter assembly and a camera module.

### Description of Related Art

In typical camera module, in order to improve photographing quality of camera module, conventionally an IR cut filter is disposed between lens and imaging sensor to filter infrared light. However, it is not always necessary to filter the infrared light through the IR cut filter.

For example, at night time, since the brightness is insufficient, an infrared light is needed to fill light for adjusting of the lightness. However, the infrared light is filtered by the IR cut filter, as a result, the brightness of the image frame captured by the camera module is insufficient. Accordingly, the above-mentioned camera module is not applicable for nighttime mode. On the other hand, the principle of current iris recognition technology utilizes infrared light to irradiate iris, and the imaging sensor receives the infrared light reflected by iris to perform iris recognition. Likewise, the IR cut filter also causes the infrared light reflected by iris to be filtered, and thus the above-mentioned camera module is not applicable for iris recognition either. If iris recognition is to be performed under the structure of the above-mentioned camera module, it is required to add another camera that is not provided with the IR cut filter; however, but the manufacturing cost of such installation is too high.

To solve the above problem, one solution is to coat two filters with different transmittance spectrums on a substrate; however, such solution limits the spectrum of light emitting source and the light-filtering effect is poor.

Another solution is to dispose a mechanical structure in the camera module to utilize the mechanical structure to switch two different filters. The mechanical structure places in or removes the IR cut filter between the lens and imaging sensor depending on whether the infrared light is needed or not. However, since the mechanical structure is added to the configuration, the volume of the camera module is too large, which makes it difficult to minimize the camera module.

### SUMMARY OF THE DISCLOSURE

The disclosure provides an adjustable filter assembly, which is capable of satisfying different light-filtering needs with small volume and low manufacturing cost.

The disclosure provides a camera module including the adjustable filter assembly, which is capable of satisfying different light-filtering needs with small volume and low manufacturing cost.

An embodiment of the discourse provides an adjustable filter assembly including a filter and two electrodes. The two electrodes are respectively coupled to a surface of the filter and electrically coupled to a controller. The controller is configured to apply a voltage to the filter and control the voltage to be changed or not. The voltage changes a state of a molecular arrangement of the filter so as to correspondingly change a transmittance spectrum of the filter, thereby selectively filtering visible light or specific non-visible light.

An embodiment of the disclosure provides a camera module including a housing, a lens barrel assembly, an imaging sensor, the abovementioned adjustable filter assembly and a controller. The lens is provided on a housing. The imaging sensor is correspondingly disposed under the lens barrel assembly. The filter is disposed between the lens barrel assembly and the imaging sensor. The controller is electrically coupled to the two electrodes. The controller is configured to apply a voltage to the filter and control the voltage to be changed or not.

In an embodiment of the disclosure, under a first mode, the controller supplies a first voltage to the filter, and a state of molecular arrangement of the filter is a first state. Under the first state, the filter is used to filter non-visible light and allow visible light to pass through. Under a second mode, the controller supplies a second voltage that is different from the first voltage to the filter, and a state of molecular arrangement of the filter is a second state that is different from the first state. Under the second state, the filter is used to filter visible light as well as a portion of non-visible light and allow another portion of non-visible light to pass through.

In an embodiment of the disclosure, the non-visible light is infrared light.

In an embodiment of the disclosure, the two electrodes are horizontally disposed at both sides of the surface of the filter.

In an embodiment of the disclosure, the filter includes a substrate and a film. The film is disposed on the substrate, and the two electrodes are disposed on the surface of the film.

In an embodiment of the disclosure, the substrate includes blue glass, new blue glass or a combination of the above.

In an embodiment of the disclosure, the film is a single-layer or multiple-layer structure, and the film includes titanium dioxide, silicon dioxide, aluminum dioxide, magnesium fluoride or a combination of the above.

In an embodiment of the disclosure, the camera module further includes a holder and a carrier. The holder has an opening. The filter is correspondingly disposed in the opening, and the lens barrel assembly and the housing are disposed on the holder. The holder and the housing stacked on the carrier. The holder and the carrier define an accommodating space. The imaging sensor is disposed in the accommodating space, and the carrier is electrically connected to the imaging sensor.

In an embodiment of the disclosure, the camera module further includes a conductive line. The controller is disposed in the carrier, and the conductive line is extended from the two electrodes to the carrier along an outer wall of the holder such that the two electrodes are electrically coupled to the controller.

According to the above, in the embodiments of the disclosure, the adjustable filter assembly and the camera module are provided with simple configuration of electrode to apply voltage to filter such that the transmittance spectrum of filter is changed, thereby selectively filtering the visible light/non-visible light. As compared with conventional technologies, the adjustable filter assembly and the camera module in the embodiments of the disclosure may satisfy different light-filtering needs with smaller volume and lower manufacturing cost.

In order to make the aforementioned features and advantages of the disclosure more comprehensible, embodiments accompanying figures are described in detail below.

### BRIEF DESCRIPTION OF THE DRAWINGS

FIG. 1 is a schematic view of a camera module according to an embodiment of the invention.

FIG. 2 is an explosive view of the camera module in FIG. 1.

FIG. 3 is a cross-sectional view of FIG. 1 taken along line I-I′.

### DESCRIPTION OF EMBODIMENTS

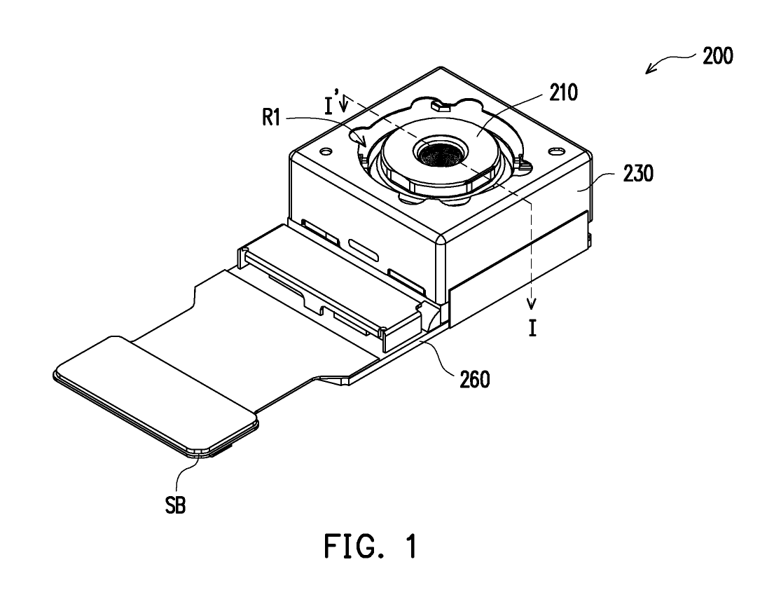

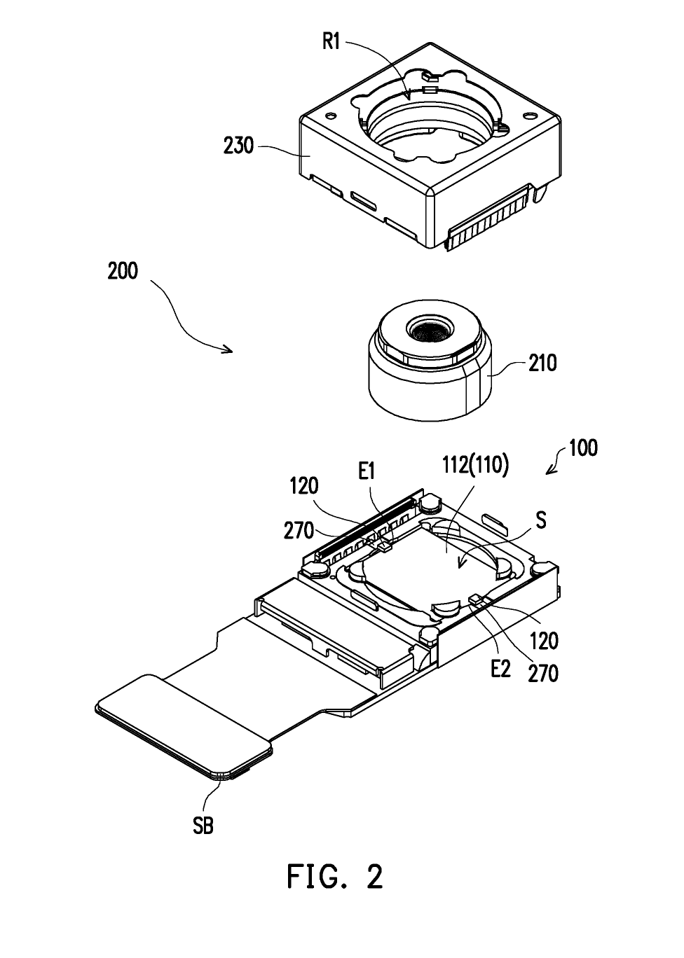

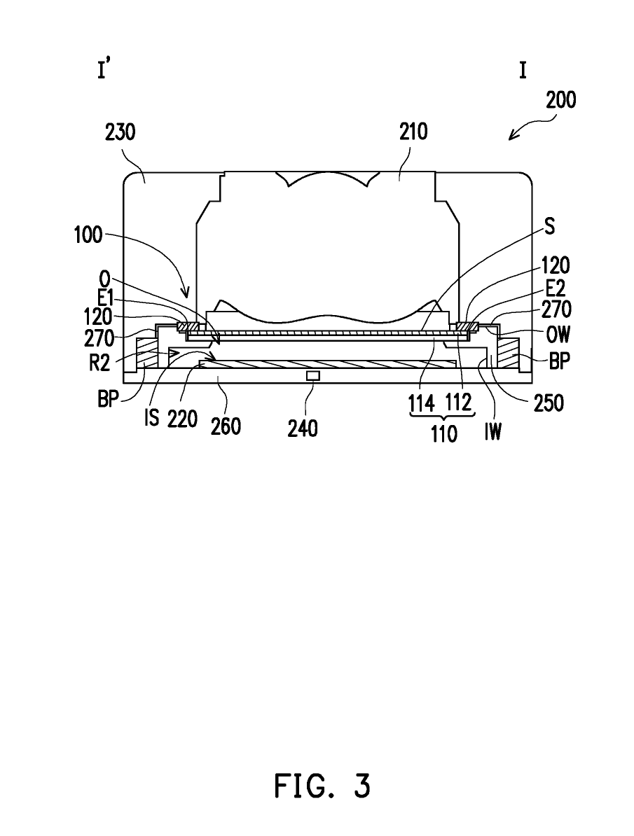

FIG. 1 is a schematic view of a camera module according to an embodiment of the invention. FIG. 2 is an explosive view of the camera module in FIG. 1. FIG. 3 is a cross-sectional view of FIG. 1 taken along line I-I′.

Referring to FIG. 1 to FIG. 3, in the embodiment, a camera module 200 includes a lens barrel assembly 210, an imaging sensor 220, an adjustable filter assembly 100, a housing 230, a controller 240, a holder 250, a carrier 260 and a conductive line 270. The adjustable filter assembly 100 includes a filter 110 and two electrodes 120. Details regarding the above elements are provided in the following paragraphs.

The lens barrel assembly 210 includes at least one lens element having refracting power, and for example, is used to receive an imaging beam from an object to be captured such that the imaging beam forms an image on an imaging surface IS of the imaging sensor 220.

The image sensor 220 is used to receive the imaging beam and convert an optical signal of the imaging beam into an electrical signal. The imaging sensor 220 includes a coupled charged device (CCD) or a complementary metal oxide semiconductor (CMOS), which should not be construed as a limitation to the invention. The imaging sensor 220 is correspondingly disposed under the lens barrel assembly 210.

The adjustable filter assembly 100 includes a filter 110 and two electrodes 120. The material of the two electrodes 120 includes a conductive paste, a metal or a combination of the above, which should not be construed as a limitation to the invention. The positive and negative electrodes 120 are coupled to a surface S of the filter 110, and disposed at both sides E1 and E2 on the same surface S of the filter 110 in a horizontal manner, for example. The two electrodes 120 and the filter 110 are electrically connected. The filter 110 is disposed between the lens barrel assembly 210 and the imaging sensor 220. In the embodiment, the filter 110 further includes the film 112 and a substrate 114. The film 112 is disposed on the substrate 114. The substrate 114, such as blue glass, new blue glass or a combination of the above, is provided in the embodiment. It should be understood that the materials set forth in the example is not to be construed as limiting of the scope of the invention. In the embodiment, the material of the film 112 includes titanium dioxide (TiO₂), silicon dioxide (SiO₂), aluminum dioxide (Al₂O₃), magnesium fluoride (MgF₂) or a combination of the above, and the film 112 may be composed of a single-layer or a multiple-layer structure, which should not be construed as a limitation to the invention. When the film 112 is a multiple-layer film, by selecting the refractive index and thickness of each film layer, the transmittance of light with various wavelengths may be controlled based on thin film interference principle.

The housing 230 has an accommodating space R1. The accommodating space R1 is a through hole. The lens barrel assembly 210 is disposed on the housing 230. Specifically, the lens barrel assembly 210 is received within the accommodating space R1 of the housing 230. The housing 230 functions to shield the imaging sensor 220 from ambient light, as well as to serve as the mounting structure for the lens barrel assembly 210.

The holder 250 has an opening O, and the filter 110 is disposed in the opening O. In this embodiment, the lens barrel assembly 210 is disposed on the holder 250. The holder 250 and the housing 230 shielded the holder 250 are stacked on the carrier 260.

The carrier 260 is, for example, a rigid circuit board, a flexible circuit board or a carrier formed by a flexible circuit thin film disposed on a rigid plate. An inner wall IW of the holder 250 and the carrier 260 define an accommodating space R2. The imaging sensor 220 is disposed on the carrier 260 and received in the accommodating space R2. The carrier 260 is electrically connected to the imaging sensor 220. The controller 240 is disposed in the carrier 260. In an embodiment, the controller 240 may be disposed on the carrier 260, the configuration of the controller 240 should not be construed as a limitation to the invention. The conductive line 270 is extended from the two electrodes 120 to a solder point BP on the carrier 260 along an outer wall OW of the holder 250 such that the two electrodes 120 are electrically coupled to the controller 240. The controller 240 is configured to apply a voltage to the filter through the two electrodes 120 and control the voltage to be changed or not. For example, the conductive line 270 is formed by using a laser direct structuring (LDS) technology, which should not be construed as a limitation to the invention. Additionally, in the embodiment, the carrier 260 may be, for example, optionally connected to an external substrate SB to be connected with external electronic elements.

In an embodiment, the controller 240 is, for example, a central processing unit (CPU), a microprocessor, a digital signal processor (DSP), a programmable controller, a programmable logic device (PLD) or other similar device or a combination of the above devices, the disclosure provides no limitation thereto. Additionally, in an embodiment, the functions of the controller 240 may be realized as a plurality of program codes. The program codes are stored in a memory and executed by the controller 240. Alternatively, in an embodiment, the functions of the controller 240 may be realized as one or more circuits. The disclosure provides no limitation to realization of the functions of the controller 240 through software or hardware.

Different light-filtering modes of the camera module 100 in the embodiment of the invention are described below.

In the embodiment, the imaging beam (not shown) is received by the lens barrel assembly 210, and forms an image on the imaging surface IS of the imaging sensor 220 through the filter 110, and whether or not the light wavelength bands in the imaging beam can pass through the filter 110 is determined by the transmittance spectrum of the filter 110. Specifically, the controller 240 applies voltage to the two electrodes 120 such that the voltage is supplied to the filter 110 and controls the voltage to be changed or not so as to change the state of molecular arrangement in the filter 110. To be more specific, the voltage causes the state of molecular arrangement (state of molecular arrangement is, for example, degree and direction of molecule orientation or density of molecules) in the film 112 of the filter 110 to change such that the overall transmittance spectrum of the filter 110 is changed correspondingly. For example, the effect generated by the change of degree and direction of molecule orientation or density of molecules is similar to the change of the size of an aperture. Since the positive and negative electrodes 120 are horizontally disposed at both sides E1 and E2 (i.e., surface of film 112) of the surface S of the filter 110, the filter 110 is conducted horizontally, for example. The controller 240 determines to apply different voltage to the filter 110 according to different light-filtering needs, and different light-filtering needs correspond to different modes. For ease of comprehension, a first mode and a second mode are exemplified below for explanation.

In the embodiment, the first mode is, for example, performed when it is needed to filter specific non-visible light, such as infrared light, in the imaging beam, and allow the visible light in the imaging beam to pass through. For example, the first mode is a general photographing mode or a daytime mode. In an embodiment, the user's need is, for example, to perform a general photographing mode, and the user may, for example, notify the controller 240 to perform the general photographing mode through a user interface. In another embodiment, the camera module 200 further includes an ambient light sensing unit (not shown). The ambient light sensing unit is used to sense the intensity of ambient light in the environment where the camera module 200 is located, and transmit the intensity of the ambient light to the controller 240 by the means of electrical signal. If the controller 240 determines that the intensity of ambient light is larger than a predetermined intensity, the controller 240 determines to use daytime mode. The general photographing mode or the daytime mode only serves as example of the first mode, which should not be construed as a limitation to the invention.

Under the first mode, the controller 240 provides a first voltage to the filter 110. In the embodiment, under the first mode, the controller 240 sets the first voltage to be, for example, 0 volt. In other embodiment, the controller 240 can set the first voltage to be non-zero volt, which should not be construed as a limitation to the invention. The state of a molecular arrangement (e.g., degree and direction of molecule orientation or density of molecules) of the filter 110 is a first state (e.g., original state of molecular arrangement of the filter 110). Under the first state, the molecular arrangement of the film 112 of the filter 110 is, for example, long axes of molecules being aligned in one direction, in substantially parallel to the plane of the substrate 114 to reflect/absorb specific non-visible light. In other words, the filter 110 may filter (cut) the non-visible light (e.g., infrared light) in the imaging beam and allow the visible light to pass through. In this manner, the intensity of the non-visible light in the imaging beam that passes through the filter 110 is smaller than the intensity of the visible light in the imaging beam. That is to say, the transmittance spectrum of the filter 110 has high transmittance in the visible light wavelength band, and has low transmittance in the non-visible light wavelength band (e. g., infrared light wavelength band). Accordingly, under the first mode, when the imaging beam passes through the filter 110 via the lens barrel assembly 210, the infrared light in the imaging beam is filtered by the filter 110. Additionally, even if a small portion of the non-visible light passes though the filter 110, the non-visible light is absorbed by the substrate 114. Therefore, the camera module 200 in the embodiment may achieve a good imaging quality. However, the first mode is not limited to the above embodiments. In other embodiments, the first mode may be set as that, when the controller 240 applies the first voltage to the filter 110, the transmittance spectrum of the filter 110 has low transmittance in the visible light wavelength band, and has high transmittance in the non-visible light wavelength band (infrared light wavelength band). In this manner, when the imaging beam passes through the filter 110 via the lens barrel assembly 210, the visible light in the imaging beam is filtered by the filter 110 and at least a portion of the non-visible light is allowed to pass through the filter 110. The choice of material and controlling method of the filter 110 may be designed depending on actual needs.

The second mode is, for example, performed when it is needed to allow at least a portion of specific non-visible light (in a desired spectrum of wavelengths, e.g., infrared light) in the imaging beam to pass through. For example, the second mode is an iris recognition mode or a nighttime mode. Since the conventional infrared light has a wavelength within range of 800 nm to 1000 nm approximately, depending on the needs, in the second mode the second voltage applied to the filter 110 may be adjusted to control the molecular arrangement of the film 112, for example, to be non-parallel to the plane of the substrate 114 such that at least a portion of the infrared light in the imaging beam can pass through in specific wavelength band (or the overall wavelength band) within the wavelength range. That is, the light with the specific wavelengths to be passed through the filter 110 can be specified to customize the filter 110 by adjusting the molecular arrangement of the film 112 as required. In an embodiment, the user, for example, uses the user interface to notify the controller 240 to perform the iris recognition mode. In another embodiment, the ambient light sensing unit is used to sense the intensity of the ambient light of the environment where the camera module 200 is located. If the controller 240 determines that the intensity of the ambient light is smaller than a predetermined intensity, the controller 240 determines to use the nighttime mode. The iris recognition mode or the nighttime mode only serves as an example of the second mode, which should not be construed as a limitation to the disclosure.

Under the second mode, the controller 240 supplies the second voltage to the filter 110. The second voltage is different from the first voltage. The degree and direction of molecule orientation or density of molecules of the filter 110 are in a second state that is different from the first state. Under the second state, the filter 110 is used to filter visible light as well as a portion of non-visible light and allow another portion of non-visible light (in a desired spectrum of wavelengths, e.g., infrared light) to pass through. Specifically, the visible light is reflected by the film 112. A portion of the non-visible light is still absorbed by the substrate 114 of the filter 110, and another portion of the non-visible light passes through the film 112 and the substrate 114. Therefore, the intensity of the non-visible light in the imaging beam that passes through the filter 110 is larger than the intensity of visible light in the imaging beam. In other words, the transmittance spectrum of the filter 110 has low transmittance in the visible light wavelength band, and has high transmittance in the non-visible light wavelength band (e.g., infrared light wavelength band). Accordingly, under the second mode, when the imaging beam passes through the filter 110 via the lens barrel assembly 210, the visible light and a portion of non-visible light in the imaging beam can be filtered by the filter 110 and another portion of non-visible light (in a desired spectrum of wavelengths, e.g., infrared light) can pass through. In this manner, the camera module 200 in the embodiment may be applicable for iris recognition/nighttime photographing and achieve a good imaging quality.

According to the aforementioned configuration, by selectively applying voltage to the filter 110 to adjust molecular arrangement of the film 112, the adjustable filter assembly 100 and the camera module 200 in the embodiment make it possible for the visible light and specific non-visible light to be selectively filtered before being transmitted to the imaging sensor 220, such that the ratio of the light intensity of visible light and the light intensity of specific non-visible light in the imaging beam that passes through the filter 110 can be adjusted, thereby satisfying different users' light-filtering needs. Additionally, when the molecules of the film 112 are arranged in inclination at a particular angle (e.g., field of view (FOV)>30 degrees), the stray light can be filtered (stray light is absorbed). With the above configuration, the adjustable filter assembly 100 and the camera module 200 in the embodiment may further eliminate flare or ghost phenomenon caused by reflection of the stray light in the device, and thus improving imaging effect.

In view of the foregoing, in the adjustable filter assembly and camera module provided by the present embodiments, without adding additional device, a simple configuration of electrodes can be used to apply voltage to the filter such that the state of molecular arrangement of the filter is changed and the transmittance spectrum of the filter is changed correspondingly, thereby satisfying different light-filtering needs. As compared with conventional technologies, the adjustable filter assembly and the camera module in the embodiments of the disclosure may satisfy different light-filtering needs with smaller volume and lower manufacturing cost.

Although the disclosure has been disclosed by the above embodiments, the embodiments are not intended to limit the disclosure. It will be apparent to those skilled in the art that various modifications and variations can be made to the structure of the disclosure without departing from the scope or spirit of the disclosure. Therefore, the protecting range of the disclosure falls in the appended claims.

What is claimed is:

1. An adjustable filter assembly, comprising:
a filter; and
two electrodes, respectively coupled to a surface of the filter and electrically coupled to a controller, the controller configured to apply a voltage to the filter and control the voltage to be changed or not,
wherein the voltage causes a state of a molecular arrangement of the filter to change such that a transmittance spectrum of the filter is changed correspondingly, thereby selectively filtering visible light or specific non-visible light.

2. The adjustable filter assembly according to claim 1, wherein
under the first mode, the controller supplies a first voltage to the filter, and the state of the molecular arrangement of the filter is a first state, under the first state, the filter is used to filter non-visible light and allow visible light to pass through,
under the second mode, the controller supplies a second voltage different from the first voltage to the filter, and the state of the molecular arrangement of the filter is a second state different from the first state, under the second state, the filter is used to filter visible light and a portion of non-visible light and allow another portion of non-visible light to pass through.

3. The adjustable filter assembly according to claim 2, wherein the filter comprises a substrate and a film, the film is disposed on the substrate, and the two electrodes are disposed on the surface of the film.

4. The adjustable filter assembly according to claim 2, wherein the non-visible light is an infrared light.

5. The adjustable filter assembly according to claim 4, wherein the filter comprises a substrate and a film, the film is disposed on the substrate, and the two electrodes are disposed on the surface of the film.

6. The adjustable filter assembly according to claim 1, wherein the two electrodes are horizontally disposed at both sides of a surface of the filter.

7. The adjustable filter assembly according to claim 1, wherein the filter comprises a substrate and a film, the film is disposed on the substrate, and the two electrodes are disposed on the surface of the film.

8. The adjustable filter assembly according to claim 7, wherein the substrate comprises a blue glass, a new blue glass or a combination of the above.

9. The adjustable filter assembly according to claim 7, wherein the film is a single-layer or multiple-layer structure, and the film comprises titanium dioxide, silicon dioxide, aluminum dioxide, magnesium fluoride or a combination of the above.

10. A camera module, comprising:
a housing;
a lens barrel assembly, disposed on the housing;
an imaging sensor, correspondingly disposed under the lens barrel assembly;
an adjustable filter assembly, comprising:
a filter, disposed between the lens barrel assembly and the imaging sensor; and
two electrodes, respectively coupled to a surface of the filter, and electrically connected to the filter; and
a controller, electrically coupled to the two electrodes, the controller configured to apply a voltage to the filter and control the voltage to be changed or not, wherein the voltage causes a state of a molecular arrangement of the filter to change such that a transmittance spectrum of the filter is changed correspondingly, thereby selectively filtering visible light or specific non-visible light.

11. The camera module according to claim 10, wherein
under the first mode, the controller supplies a first voltage to the filter, and the state of the molecular arrangement of the filter is a first state, under the first state, the filter is used to filter non-visible light and allow visible light to pass through,
under the second mode, the controller supplies a second voltage different from the first voltage to the filter, and the state of the molecular arrangement of the filter is a second state different from the first state, under the second state, the filter is used to filter visible light and a portion of non-visible light and allow another portion of non-visible light to pass through.

12. The camera module according to claim 11, wherein the filter comprises a substrate and a film, the film is disposed on the substrate, and the two electrodes are disposed on the surface of the film.

13. The camera module according to claim 11, wherein the non-visible light is an infrared light.

14. The camera module according to claim 13, wherein the filter comprises a substrate and a film, the film is disposed on the substrate, and the two electrodes are disposed on the surface of the film.

15. The camera module according to claim 10, wherein the two electrodes are horizontally disposed at both sides of a surface of the filter.

16. The camera module according to claim 10, wherein the filter comprises a substrate and a film, the film is disposed on the substrate, and the two electrodes are disposed on the surface of the film.

17. The camera module according to claim 16, wherein the substrate comprises a blue glass, a new blue glass or a combination of the above.

18. The camera module according to claim 16, wherein the film is a single-layer or multiple-layer structure, and the film comprises titanium dioxide, silicon dioxide, aluminum dioxide, magnesium fluoride or a combination of the above.

19. The camera module according to claim 10, further comprising:
a holder, having an opening, the filter correspondingly disposed in the opening, and the lens barrel assembly and the housing disposed on the holder; and
a carrier, the holder and the housing stacked on the carrier, the holder and the carrier defining an accommodating space, the imaging sensor disposed in the accommodating space, and the carrier electrically connected to the imaging sensor.

20. The camera module according to claim 19, further comprising a conductive line, wherein the controller is disposed on the carrier, and the conductive line is extended from the two electrodes to the carrier along an outer wall of the holder such that the two electrodes are electrically coupled to the controller.
